(19) United States
(12) Patent Application Publication
(10) Pub. No.: US 2026/0330682 A1
(43) Pub. Date: Oct. 22, 2026

(54) DETERMINATION OF A CONTOUR PHYSICAL DISTANCE WITHIN A SUBJECT BASED ON A DEFORMABLE THREE-DIMENSIONAL MODEL

(71) Applicant: Intuitive Surgical Operations, Inc., Sunnyvale, CA (US)

(72) Inventors: Pourya Shirazian, Menlo Park, CA (US); Kenneth K. Lee, Oakton, VA (US)

(21) Appl. No.: 19/104,576

(22) PCT Filed: Sep. 7, 2023
(86) PCT No.: PCT/US2023/032175

§ 371 Date: Feb. 18, 2025

Related U.S. Application Data
(60) Provisional application No. 63/405,561, filed on Sep. 12, 2022.

(51) Int. Cl. G06T 7/73; G06T 7/13; G06T 7/246; G06T 7/60; G06T 15/20; G06T 17/00

(52) U.S. Cl. CPC G06T 7/75; G06T 7/13; G06T 7/251; G06T 7/60; G06T 15/205; G06T 17/00; G06T 2207/10012; G06T 2207/20101; G06T 2207/30004; G06T 2210/41; G06T 2210/56

(57) ABSTRACT

An illustrative dynamic measurement system may be configured to generate, based on imagery of a scene, a deformable 3D model of the scene, identify a first point on an anatomical object located in the scene, and determine, based on the deformable 3D model, a dynamic measurement value representative of a contour physical distance between the first point and a second point in the scene. The dynamic measurement value may dynamically update with movement of one or more objects within the scene.

### BACKGROUND INFORMATION

The present application claims priority to U.S. Provisional Patent Application No. 63/405,561, filed Sep. 12, 2022, the contents of which is hereby incorporated by reference in its entirety.

BACKGROUND INFORMATION During a medical procedure, such as a procedure that utilizes a computer-assisted medical system, an imaging device may be used to provide images (e.g., stereoscopic video) of internal anatomy within a subject (e.g., to a surgeon). In some scenarios, it may be desirable to measure various distances associated with the internal anatomy for the procedure. For example, it may be desirable to measure a size of a hernia within the subject so that a mesh patch may be appropriately sized to fit the hernia. As another example, it may be desirable to ascertain how far away a tip of a surgical instrument is from tissue within the subject.

Unfortunately, direct physical access to the internal anatomy may not be available (e.g., during a minimally invasive medical procedure), which may render such measurements difficult to accurately ascertain. For example, surface contours of the internal anatomy may occlude portions of the internal anatomy from the imaging device and/or portions of the internal anatomy may be located outside of a field of view of the imaging device.

### SUMMARY

The following description presents a simplified summary of one or more aspects of the systems and methods described herein. This summary is not an extensive overview of all contemplated aspects and is intended to neither identify key or critical elements of all aspects nor delineate the scope of any or all aspects. Its purpose is to present one or more aspects of the systems and methods described herein as a prelude to the detailed description that is presented below.

An illustrative system includes a memory storing instructions and one or more processors communicatively coupled to the memory. The one or more processors may be configured to execute the instructions to perform a process comprising: generating, based on imagery of a scene, a deformable three-dimensional (3D) model of the scene; identifying a first point on an anatomical object located in the scene; and determining, based on the deformable 3D model, a dynamic measurement value representative of a contour physical distance between the first point and a second point in the scene. The dynamic measurement value may dynamically update with movement of one or more objects within the scene.

An illustrative method includes generating, by at least one computing device and based on imagery of a scene, a deformable 3D model of the scene; identifying, by the at least one computing device, a first point on an anatomical object located in the scene; and determining, by the at least one computing device and based on the deformable 3D model, a dynamic measurement value representative of a contour physical distance between the first point and a second point in the scene, wherein the dynamic measurement value dynamically updates with movement of one or more objects within the scene.

An illustrative non-transitory computer-readable medium may store instructions that, when executed, direct a processor of a computing device to perform a process comprising: generating, based on imagery of a scene, a deformable 3D model of the scene; identifying a first point on an anatomical object located in the scene; and determining, based on the deformable 3D model, a dynamic measurement value representative of a contour physical distance between the first point and a second point in the scene, wherein the dynamic measurement value dynamically updates with movement of one or more objects within the scene.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows an illustrative implementation including a dynamic measurement system.

FIG. 2 shows another illustrative implementation including a dynamic measurement system.

FIG. 3 shows an illustrative method of operating a dynamic measurement system.

FIG. 4 shows another illustrative method of operating a dynamic measurement system.

FIGS. 5A and 5B show illustrative implementations of generating a deformable 3D model using a dynamic measurement system.

FIGS. 6A and 6B show illustrative implementations of determining a dynamic measurement value using a dynamic measurement system.

FIG. 7 shows an illustrative implementation of a display that may be generated using a dynamic measurement system.

FIG. 8 shows an illustrative computer-assisted medical system that may incorporate a dynamic measurement system.

FIG. 9 shows an illustrative computing system according to principles described herein.

### DETAILED DESCRIPTION

An illustrative dynamic measurement system may be configured to determine a dynamic measurement of a contour physical distance between points within a scene based on a deformable 3D model of the scene. For example, the dynamic measurement system may be configured to generate, based on imagery (e.g., as captured by an imaging device) of a scene (e.g., an area within a subject of a medical procedure), a deformable 3D model of the scene. The dynamic measurement system may further be configured to identify a first point on an anatomical object located in the scene and determine, based on the deformable 3D model, a dynamic measurement value representative of a contour physical distance between the first point and a second point in the scene.

In some implementations, the deformable 3D model may be generated in real-time during the medical procedure based on the imagery of the scene. This may allow the deformable 3D model to depict movement of one or more objects within the scene as the one or more objects deform (e.g., due to breathing and/or force applied by an instrument during a medical procedure), which may cause the contour physical distance to change. Accordingly, the dynamic measurement value may dynamically update with movement of the one or more objects within the scene based on the deformable 3D model.

The principles described herein may result in improved dynamic measurements compared to conventional techniques that are not based on a deformable 3D model, as well as provide other benefits as described herein. For example, the determination of a dynamic measurement value based on a deformable 3D model may allow the dynamic measurement value to be determined more accurately and/or efficiently. To illustrate, the determination of the dynamic measurement value based on a deformable 3D model may account for surface contours of anatomical objects, which may decrease occlusion issues caused by the surface contours, and/or account for anatomical objects located outside of a field of view of an imaging device, which may increase an area for the determination of the dynamic measurement value. Moreover, the determination of the dynamic measurement value based on a deformable 3D model may allow the dynamic measurement value to be dynamically updated, such as while one or more anatomical objects within the scene are deformed.

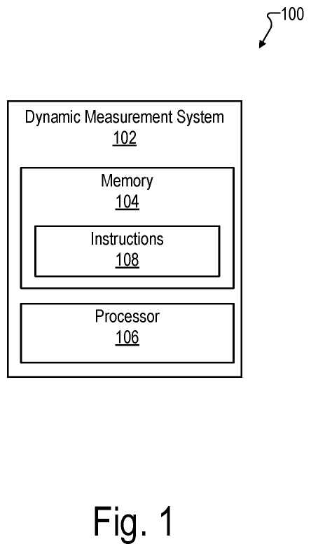

FIG. 1 shows an illustrative implementation 100 configured to determine a dynamic measurement value representative of a contour physical distance along a scene based on a deformable 3D model of the scene. As shown, implementation 100 includes a dynamic measurement system 102 configured to generate, based on imagery of a scene, a deformable 3D model of the scene, identify a first point on an anatomical object located in the scene, and determine, based on the deformable 3D model, a dynamic measurement value representative of a contour physical distance between the first point and a second point in the scene. Implementation 100 may include additional or alternative components as may serve a particular implementation. In some examples, implementation 100 or certain components of implementation 100 may be implemented by a computer-assisted medical system.

Dynamic measurement system 102 may be implemented by one or more computing devices and/or computer resources (e.g., processors, memory devices, storage devices, etc.) as may serve a particular implementation. As shown, dynamic measurement system 102 may include, without limitation, a memory 104 and a processor 106 selectively and communicatively coupled to one another. Memory 104 and processor 106 may each include or be implemented by computer hardware that is configured to store and/or process computer software. Various other components of computer hardware and/or software not explicitly shown in FIG. 1 may also be included within dynamic measurement system 102. In some examples, memory 104 and/or processor 106 may be distributed between multiple devices and/or multiple locations as may serve a particular implementation.

Memory 104 may store and/or otherwise maintain executable data used by processor 106 to perform any of the functionality described herein. For example, memory 104 may store instructions 108 that may be executed by processor 106. Memory 104 may be implemented by one or more memory or storage devices, including any memory or storage devices described herein, that are configured to store data in a transitory or non-transitory manner. Instructions 108 may be executed by processor 106 to cause dynamic measurement system 102 to perform any of the functionality described herein. Instructions 108 may be implemented by any suitable application, software, code, and/or other executable data instance. Additionally, memory 104 may also maintain any other data accessed, managed, used, and/or transmitted by processor 106 in a particular implementation.

Processor 106 may be implemented by one or more computer processing devices, including general purpose processors (e.g., central processing units (CPUs), graphics processing units (GPUs), microprocessors, etc.), special purpose processors (e.g., application specific integrated circuits (ASICs), field-programmable gate arrays (FPGAs), etc.), image signal processors, or the like. Using processor 106 (e.g., when processor 106 is directed to perform operations represented by instructions 108 stored in memory 104), dynamic measurement system 102 may perform various operations as described herein.

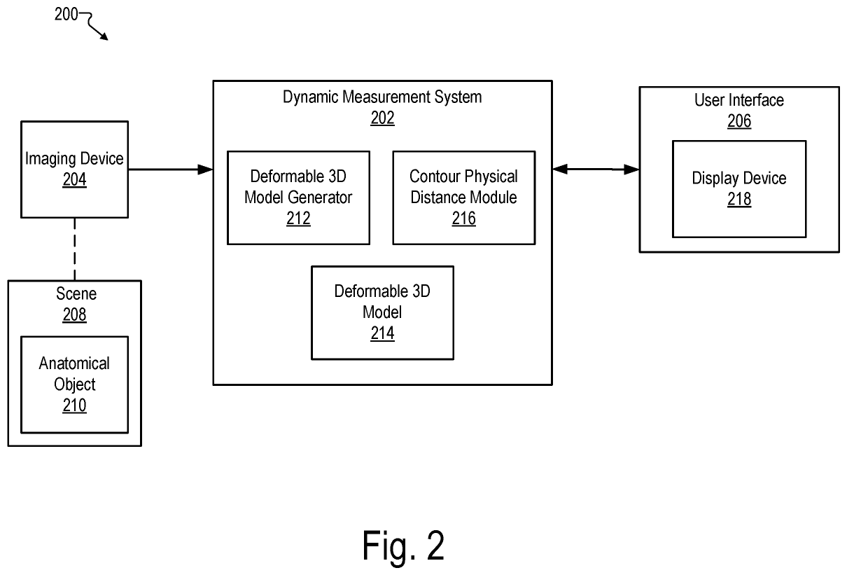

FIG. 2 shows another illustrative implementation 200 configured to determine a dynamic measurement value representative of a contour physical distance along a scene based on a deformable 3D model of the scene. As shown, implementation 200 includes a dynamic measurement system 202 communicatively coupled (e.g., wired and/or wirelessly) with an imaging device 204 and a user interface 206. Implementation 200 may include additional or alternative components as may serve a particular implementation. In some examples, implementation 200 or certain components of implementation 200 may be implemented by a computer-assisted medical system.

Imaging device 204 may be implemented by an endoscope or other suitable device configured to capture and output imagery (e.g., images, videos, a sequence of image frames, etc.) of a scene 208. In some implementations, imaging device 204 may include, but is not limited to, one or more of: video imaging devices, infrared imaging devices, visible light imaging devices, non-visible light imaging devices, intensity imaging devices (e.g., color, grayscale, black and white imaging devices), depth imaging devices (e.g., stereoscopic imaging devices, time-of-flight imaging devices, infrared imaging devices, red-green-blue (RGB) imaging devices, red-green-blue and depth (RGB-D) imaging devices, light detection and ranging (LIDAR) imaging devices, etc.).

In some implementations, the imagery may include image data (e.g., color, grayscale, saturation, intensity, brightness, depth, etc.) captured by imaging device 204. The image data may, in some instances, be associated with data points expressed in a common coordinate frame such as 3D voxels or two-dimensional (2D) pixels of images captured by imaging device 204. In some implementations, imaging device 204 may be moved relative to scene 208 to capture imagery of scene 208 at different viewpoints.

Scene 208 may include an environment (e.g., an area within a subject of a medical procedure) and/or one or more objects within an environment. For example, scene 208 may include an anatomical object 210. Anatomical object 210 may include an object associated with a subject (e.g., a body of a live animal, a human or animal cadaver, a portion of human or animal anatomy, tissue removed from human or animal anatomies, non-tissue work pieces, training models, etc.). In some implementations, anatomical object 210 may include tissue of a subject (e.g., an organ, soft tissue, connective tissue, etc.). Still other non-anatomical objects may be included within scene 208, such as physical tools (e.g., scalpels, scissors, forceps, clamps, etc.) and/or other objects (e.g., staples, mesh, sponges, etc.) used for a medical procedure.

Dynamic measurement system 202 may implement or be similar to dynamic measurement system 102 and may be configured to receive imagery of scene 208 from imaging device 204. In some implementations, dynamic measurement system 202 may be configured to fuse imagery of scene 208 captured by imaging device 204 at different viewpoints of scene 208. In certain examples, the fusing may include merging aligned (or overlapping) voxels or pixels, such as by blending intensity and/or depth values for aligned voxels or pixels. The blending may include weighted blending in which the data points being blended are weighted based on one or more factors, such as which camera of a stereoscopic device has the best view of a data point (e.g., by more heavily weighting data captured by the camera with the best viewing angle). The fusing may additionally or alternatively include stitching non-overlapping voxels or pixels together, such as by stitching images together along non-overlapping boundaries of the images. Accordingly, the fusing of imagery at different viewpoints may allow the imagery of scene 208 to include an area that is larger than a single field of view of imaging device 204.

As shown, dynamic measurement system 202 includes a deformable 3D model generator 212 configured to generate a deformable 3D model 214 based on imagery of scene 208. For example, deformable 3D model generator 212 may be configured to generate a point cloud having a plurality of nodes representative of surface points on one or more objects (e.g., anatomical object 210) within scene 208 as depicted in imagery captured by imaging device 204. Deformable 3D model generator 212 may further be configured to generate vertices associated with 3D locations that correspond to 3D locations of the plurality of nodes from the imagery. In instances where the plurality of nodes is based on 2D imagery, deformable 3D model generator 212 may be configured to determine a depth associated with the plurality of nodes, such as by processing stereoscopic images captured by imaging device 204. Additionally or alternatively, a depth map of scene 208 may be generated using a depth sensor.

Deformable 3D model generator 212 may further be configured to deform deformable 3D model 214 over time with the movement of one or more objects within scene 208. For example, anatomical object 210 within scene 208 may be deformed during a medical procedure. Such deformation may be caused by the expansion and/or contraction of anatomical object 210 (e.g., while a subject of a medical procedure is breathing), by movement of another object (e.g., one physically connected to anatomical object 210) in scene 208, and/or by a force applied to anatomical object 210 (e.g., by a physical tool, a human finger, etc.). Other non-anatomical objects may move within scene 208 in addition to or instead of anatomical object 210 (e.g., a physical tool may move relative to anatomical object 210).

To illustrate, the 3D locations of the vertices of deformable 3D model 214 may track the 3D locations of the plurality of nodes associated with the vertices as the 3D locations of the plurality of nodes update in the imagery captured by imaging device 204 with the movement of the one or more objects within scene 208. This may allow deformable 3D model 214 to deform over time with the movement of the one or more objects within scene 208. In some implementations, deformable 3D model generator 212 may be configured to detect deformation of deformable 3D model 214, such as by comparing the 3D locations of the vertices of deformable 3D model 214 at two or more different points of time. Additionally or alternatively, a first 3D model, which may be deformable or nondeformable, may be generated at a first point of time and a second 3D model, which may be deformable or nondeformable, may be generated at a second point of time that is different than the first point of time such that the first and second 3D models may be compared with each other to detect deformation.

In some implementations, a simultaneous localization and mapping (SLAM) heuristic may be used by deformable 3D model generator 212 to construct and/or update a map of scene 208 while simultaneously keeping track of the location of objects within scene 208. For example, the SLAM heuristic may be configured to generate the point cloud having the plurality of nodes representative of surface points on one or more objects within scene 208 and derive and/or associate vertices of deformable 3D model 214 with 3D locations that correspond to 3D locations of the plurality of nodes as imaging device 204 views scene 208 in real-time. The SLAM heuristic may further be configured to derive and/or associate additional vertices of deformable 3D model 214 with 3D locations that correspond to 3D locations of additional nodes as imaging device 204 is moved relative to scene 208 to capture additional areas of scene 208, while also tracking the 3D locations of the previous vertices of deformable 3D model 214 with the 3D locations of the previous nodes associated as one or more objects within scene 208 move and/or deform. In some implementations, the SLAM heuristic may be configured to track a pose of imaging device 204 (e.g., using vision software) while imaging device 204 is moved relative to scene 208.

Still other suitable configurations may be used to generate and/or update deformable 3D model 214 with movement of one or more objects within scene 208. For example, deformable 3D model generator 212 may be configured to generate deformable 3D model 214 based on preoperative imagery of scene 208. Additionally or alternatively, the movement of one or more objects within scene 208 may be determined based on kinematic data representative of movement of the one or more objects over time. For example, the kinematic data may be generated by or associated with a computer-assisted medical system communicatively coupled with the one or more objects (e.g., a physical tool).

Dynamic measurement system 202 further includes a contour physical distance module 216 configured to determine, based on deformable 3D model 214, a dynamic measurement value representative of a contour physical distance along scene 208 and output the dynamic measurement value to user interface 206. For example, the contour physical distance may be representative of a distance between two or more points within scene 208 that may extend over a physical surface of one or more objects within scene 208. The dynamic measurement value may be represented by any suitable value, such as a discrete value (e.g., a distance, a range, a percentage, etc.) representative of the contour physical distance.

To illustrate, contour physical distance module 216 may be configured to determine a 3D contour that may extend along a surface of one or more objects of the deformable 3D model 214 and connect the two or more points within scene 208 such that the 3D contour may be representative of the contour physical distance between the two or more points. In some implementations, the two or more points may be associated with vertices of deformable 3D model 214. Additionally, contour physical distance module 216 may be configured to identify one or more additional vertices of deformable 3D model 214 between the two or more points on the 3D contour. This may allow contour physical distance module 216 to determine intermediate distances for each segment of a linear-segmented route that passes through the 3D locations of each adjacent vertex of deformable 3D model 214. Based on the intermediate distances, contour physical distance module 216 may compute the dynamic measurement value as a sum of the intermediate distances. The sum of the intermediate distances may provide an estimation for an exact contour physical distance, which may become more accurate as more vertices and/or intermediate distances are defined. Additionally or alternatively, contour physical distance module 216 may determine a direct point-to-point distance between the 3D locations of each point of the two or more points.

In some implementations, the dynamic measurement value representative of the physical contour distance may change with the movement of one or more objects within scene 208. Accordingly, contour physical distance module 216 may be configured to dynamically update the dynamic measurement value with the movement of the one or more objects. For example, contour physical distance module 216 may be configured to recompute the intermediate distances between the 3D locations of the identified vertices of deformable 3D model 214 as the 3D locations of the identified vertices are updated with the movement of the one or more objects. Still other suitable configurations for determining the dynamic measurement value may be used. Moreover, dynamic measurement system 202 may include additional or alternative components as may serve a particular implementation.

User interface 206 may be configured to receive the dynamic measurement value from dynamic measurement system 202. User interface 206 of the illustrated implementation includes a display device 218. Display device 218 may be implemented by a monitor or other suitable device configured to display information to a user. For example, display device 218 may be configured to display the dynamic measurement value received from dynamic measurement system 202. In some implementations, display device 218 may further be configured to display imagery of scene 208 captured by imaging device 204 and/or deformable 3D model 214 generated by dynamic measurement system 202. Additionally or alternatively, user interface 206 may include any suitable device (e.g., a button, joystick, touchscreen, keyboard, handle, etc.) configured to receive a user input such as to identify points within scene 208 for determining the dynamic measurement value.

In some implementations, dynamic measurement system 202 may be configured to determine multiple dynamic measurements within scene 208. As an illustrative example, dynamic measurement system 202 may be configured to determine a distance between a physical tool and multiple anatomical objects 210 within scene 208. Moreover, dynamic measurement system 202 may be configured to mark, track, and/or present the multiple dynamic measurements. For example, dynamic measurement system 202 may be configured to mark (e.g., highlight) the physical tool, the multiple anatomical objects 210, and/or distances between the physical tool and multiple anatomical objects 210 (e.g., on a display of display device 218). Dynamic measurement system 202 may further be configured to track and update the multiple dynamic measurements as the physical tool is moved relative to the multiple anatomical objects 210. Dynamic measurement system 202 may further be configured to present (e.g., label) the multiple dynamic measurements to a user (e.g., on a display of display device 218).

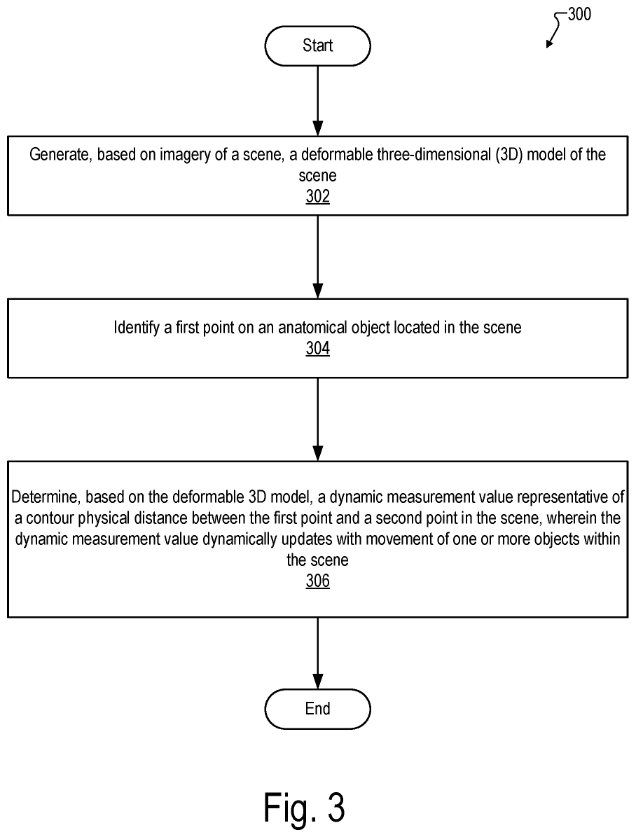

FIG. 3 shows an illustrative method 300 that may be performed by dynamic measurement system 202. While FIG. 3 illustrates exemplary operations according to one embodiment, other embodiments may omit, add to, reorder, and/or modify any of the operations shown in FIG. 3. Moreover, each of the operations depicted in FIG. 3 may be performed in any of the ways described herein.

As shown, dynamic measurement system 202 may, at operation 302, generate, based on imagery of scene 208, deformable 3D model 214 of scene 208. For example, dynamic measurement system 202 may generate a point cloud having a plurality of nodes representative of surface points on one or more objects (e.g., anatomical object 210) within scene 208 and derive vertices associated with 3D locations that correspond to 3D locations of the plurality of nodes (e.g., using a SLAM heuristic). The 3D locations of the vertices of deformable 3D model 214 may update with the corresponding 3D locations of the plurality of nodes as the 3D locations of the plurality of nodes move with the movement of the one or more objects within scene 208. This may allow deformable 3D model 214 to deform over time with the movement of the one or more objects within scene 208.

Dynamic measurement system 202 may further, at operation 304, identify a first point on anatomical object 210 located in scene 208. In some implementations, the identifying the first point may include detecting a user input designating the first point on anatomical object 210. For example, dynamic measurement system 202 may be configured to receive the user input by displaying imagery of scene 208 captured by imaging device 204 and/or deformable 3D model 214 on display device 218. A designation of the first point may be performed as a discrete event (e.g., a touch gesture, a button press, a mouse click, a button release, etc.) on any point of the imagery of scene 208 and/or deformable 3D model 214 on display device 218.

Once the user input has been received, dynamic measurement system 202 may associate the first point with a 3D location (e.g., a vertex) on deformable 3D model 214. In some implementations, the first point may be identified on an outer surface of anatomical object 210, such as a feature on anatomical object 210 (e.g., an edge of a hernia).

In some implementations, the identifying the first point may include implementing and applying artificial intelligence algorithms, such as machine learning algorithms, to designate the first point on anatomical object 210 located in scene 208.

Any suitable form of artificial intelligence and/or machine learning may be used, including, for example, deep learning, neural networks, etc. For example, a machine learning algorithm may be generated through machine learning procedures and applied to identification operations. In some implementations, the machine learning algorithm may be directed to identifying an anatomical object 210 and/or a feature of anatomical object 210 within scene 208. The machine learning algorithm may operate as an identification function that is applied to individual and/or fused imagery to classify anatomical object 210 in the imagery.

Still other suitable methods may be used for identifying the first point on anatomical object 210 in addition to or instead of machine learning algorithms. For example, dynamic measurement system 202 may be configured to identify the first point on anatomical object 210 within scene 208 by implementing and applying object recognition algorithms. For example, an object recognition algorithm may be used to identify objects (e.g., anatomical object 210) of predetermined types within the image data received from imaging device 204, such as by comparing the image data received from imaging device 204 to model object data of predetermined types of objects. Such model object data may be stored within a model database that may be communicatively coupled with dynamic measurement system 202.

In some implementations, dynamic measurement system 202 may further identify a second point in scene 208. The second point may be spaced a distance away from the first point in scene 208. For example, the second point may be identified on the same anatomical object 210 as the first point, on a different anatomical object 210 from the first point, on a non-anatomical object (e.g., a physical tool) within scene 208, and/or another area within scene 208. In some implementations, the second point may correspond to another feature on anatomical object 210 (e.g., an opposing edge of a hernia). In certain embodiments, the first and second points are spaced sufficiently apart that one may be located outside of a field of view of the imaging device.

The identifying the second point may include detecting a user input designating the second point in scene 208. For example, dynamic measurement system 202 may be configured to receive the user input by displaying imagery of scene 208 captured by imaging device 204 and/or deformable 3D model 214 on display device 218. A designation of the second point may be performed as a discrete event (e.g., a touch gesture, a button press, a mouse click, a button release, etc.) on any point of the imagery of scene 208 and/or deformable 3D model 214 on display device 218.

Once the user input has been received, dynamic measurement system 202 may associate the second point with a 3D location (e.g., a vertex) on deformable 3D model 214. In some implementations, the second point may be identified on an outer surface of an anatomical object 210.

Additionally or alternatively, the identifying the second point may include implementing and applying artificial intelligence algorithms, such as machine learning algorithms, to designate the second point in scene 208. Any suitable form of artificial intelligence and/or machine learning may be used, including, for example, deep learning, neural networks, etc. For example, a machine learning algorithm may be generated through machine learning procedures and applied to identification operations. In some implementations, the machine learning algorithm may be directed to identifying an object and/or a feature of an object within scene 208. The machine learning algorithm may operate as an identification function that is applied to individual and/or fused imagery to classify an object in the imagery.

Still other suitable methods may be used for identifying the second point in scene 208 in addition to or instead of machine learning algorithms. For example, dynamic measurement system 202 may be configured to identify the second point in scene 208 by implementing and applying object recognition algorithms. For example, an object recognition algorithm may be used to identify objects (e.g., an anatomical object 210, physical tools, etc.) of predetermined types within the image data received from imaging device 204, such as by comparing the image data received from imaging device 204 to model object data of predetermined types of objects. Such model object data may be stored within a model database that may be communicatively coupled with dynamic measurement system 202.

Dynamic measurement system 202 may further, at operation 306, determine, based on deformable 3D model 214, a dynamic measurement value representative of a contour physical distance between the first point and the second point in scene 208.

For example, dynamic measurement system 202 may be configured to determine a distance between the 3D locations of the vertices associated with the first and second points along a surface of deformable 3D model 214. In some implementations, dynamic measurement system 202 may identify intermediate vertices along a surface of deformable 3D model 214 between the first and second points to derive a 3D contour that connects the first and second points through the intermediate vertices. The dynamic measurement value may be computed as a sum of the intermediate distances between the 3D locations of the intermediate vertices on the 3D contour.

Dynamic measurement system 202 may be configured to dynamically update the dynamic measurement value with movement of one or more objects within scene 208. For example, the 3D locations of the vertices of deformable 3D model 214 associated with at least one of the first point or the second point may move as anatomical object 210 is deformed. Additionally or alternatively, the 3D locations of the intermediate vertices on the 3D contour extending between the first and second points may update with movement of one or more objects within scene 208. These changes in the 3D locations of the vertices may affect the intermediate distances between the vertices. Accordingly, the intermediate distances may be recomputed as the 3D locations of the vertices are updated to dynamically update the dynamic measurement value.

In some implementations, the dynamic measurement value may be dynamically updated based on the 3D locations of the vertices corresponding to each sequential image frame of the imagery captured by imaging device 204. Additionally or alternatively, the dynamic measurement value may be dynamically updated based on the 3D locations of the vertices corresponding to a plurality of image frames over time. For example, the dynamic measurement value may represent a combination (e.g., an average, a mean, a median, etc.) of measurements over the plurality of image frames.

In some implementations, the dynamic measurement value may represent a difference in the contour physical distance based on the movement of the one or more objects within scene 208. For example, dynamic measurement system 202 may detect changes of the 3D locations of the vertices on the 3D contour of deformable 3D model 214 and compare the distance between the 3D locations of the vertices at two different points of time. Additionally or alternatively, the change in the distance between the 3D locations of the vertices may be determined by comparing the 3D locations of the vertices in a first 3D model, which may be deformable or nondeformable, generated at a first point of time and with 3D locations of corresponding vertices in a second 3D model, which may be deformable or nondeformable, generated at a second point of time. Still other suitable methods for determining the dynamic measurement value may be used. For example, while the dynamic measurement value is described above as being representative of a contour physical distance between two points, additional points may be identified in scene 208 for determining the dynamic measurement value.

In some implementations, method 300 may further include performing, by dynamic measurement system 202, an operation based on the dynamic measurement value. For example, dynamic measurement system 202 may be configured to instruct one or more display devices (e.g., display device 218) to display the imagery depicting scene 208 and/or deformable 3D model 214. Dynamic measurement system 202 may further display the dynamic measurement value and/or the 3D contour (e.g., on the imagery depicting scene 208 and/or deformable 3D model 214). In some implementations, dynamic measurement system 202 may be configured to receive user input to designate one or more intermediate vertices of deformable 3D model 214 that define the 3D contour such that the 3D contour may be adjusted by a user.

The operation may further include determining a size (e.g., a length, a width, a surface area, a volume, etc.) of an object (e.g., anatomical object 210) and/or a feature of an object within scene 208 based on the dynamic measurement value. As an example, dynamic measurement system 202 may determine, based on the dynamic measurement value, a size of a hernia on anatomical object 210 so that a mesh patch may be appropriately sized to fit the hernia. To illustrate, the dynamic measurement value may be dynamically updated as the hernia deforms (e.g., due to breathing and/or insufflation) such that the size of the mesh patch may be selected or adjusted based on the dynamic updates of the dynamic measurement value. As another example, dynamic measurement system 202 may determine a length of a bowel (e.g., during a lower anterior resection procedure) based on a dynamic measurement value that may be dynamically updated as the length of the bowel is stretched and/or compressed. The dynamic measurement value may further provide a reference for a size of a lung (e.g., during a thoracic surgery). For example, the dynamic measurement value may be dynamically updated as the lung is deformed. As another example, dynamic measurement system 202 may be configured to determine, based on the dynamic measurement value, how far away a tip of a physical tool is from anatomical object 210 during a medical procedure.

In some implementations, dynamic measurement system 202 may be configured to track changes (e.g., dynamic updates) of the dynamic measurement value (e.g., due to movement of the one or more objects within scene 208). For example, dynamic measurement system 202 may determine a change of the dynamic measurement value, such as by determining a difference between the dynamic measurement value and a previous dynamic measurement value. The change of the dynamic measurement value may indicate an effectiveness and/or progress of a surgical step (e.g., insufflation).

Additionally, dynamic measurement system 202 may be configured to instruct one or more display devices (e.g., display device 218) to display the change of the dynamic measurement value. The change of the dynamic measurement value may be represented by any suitable value, such as a discrete value (e.g., a distance, a range, a percentage, etc.) representative of the change of the dynamic measurement value. To illustrate, the change of the dynamic measurement value may be displayed as a percentage (e.g., relative to an initial dynamic measurement value). In some implementations, dynamic measurement system 202 may be configured to selectively display one or both of the dynamic measurement value and the change of the dynamic measurement value, such as based on a user input designating to display the dynamic measurement value and/or the change of the dynamic measurement value.

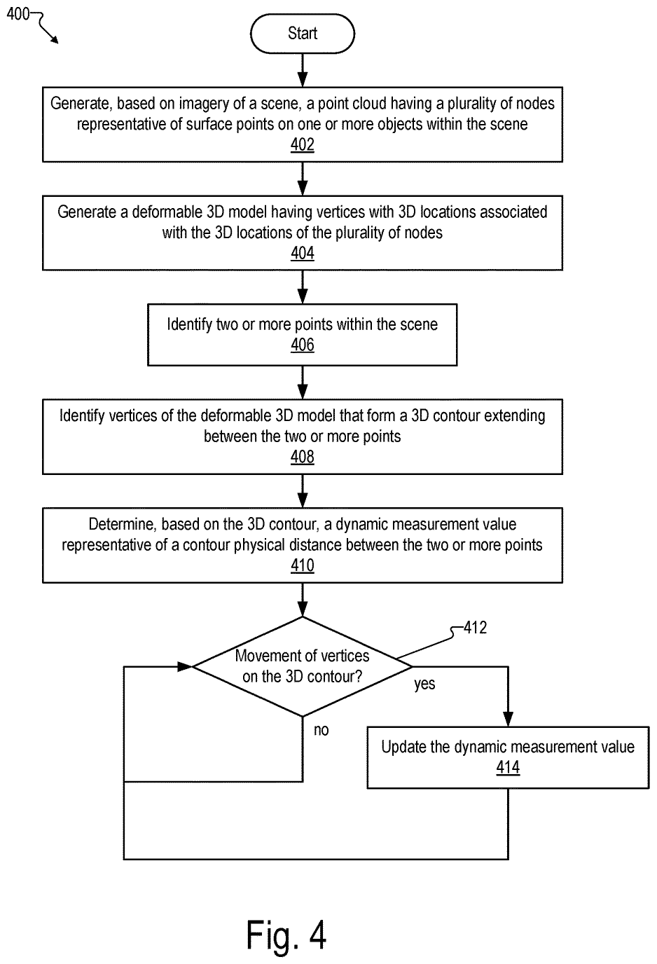

FIG. 4 shows another illustrative method 400 that may be performed by dynamic measurement system 202. While FIG. 4 illustrates exemplary operations according to one embodiment, other embodiments may omit, add to, reorder, and/or modify any of the operations shown in FIG. 4. Moreover, each of the operations depicted in FIG. 4 may be performed in any of the ways described herein.

As shown, dynamic measurement system 202 may, at operation 402, generate, based on imagery of scene 208 (e.g., as captured by imaging device 204), a point cloud having a plurality of nodes representative of surface points on one or more objects (e.g., anatomical object 210) within scene 208. Dynamic measurement system 202 may further, at operation 404, generate deformable 3D model 214 having vertices with 3D locations associated with the 3D locations of the plurality of nodes.

Dynamic measurement system 202 may further, at operation 406, identify two or more points within scene 208. In some implementations, these points may be identified by receiving a user input (e.g., via user interface 206) designating the two or more points on the imagery of scene 208 and/or deformable 3D model 214. In some implementations, at least one of the two or more points may be located on anatomical object 210 within scene 208. The remaining point(s) may be positioned on the same anatomical object 210, a different anatomical object 210, a physical tool, and/or another area within scene 208.

Dynamic measurement system 202 may further, at operation 408, identify vertices of deformable 3D model 214 that form a 3D contour connecting the two or more points. For example, dynamic measurement system 202 may identify vertices of deformable 3D model 214 having 3D locations that correspond to the identified two or more points within scene 208. Dynamic measurement system 202 may further identify one or more additional vertices of deformable 3D model 214 having 3D locations positioned between the vertices corresponding to the identified two or more points. The 3D contour may be formed to connect the identified vertices such that the 3D contour may extend along a surface of deformable 3D model 214 between the identified two or more points.

Dynamic measurement system 202 may further, at operation 410, determine, based on the 3D contour, a dynamic measurement value representative of a contour physical distance between the two or more points. For example, dynamic measurement system 202 may be configured to sum the distances between the 3D locations of adjacent vertices on the 3D contour of deformable 3D model 214 to determine the dynamic measurement value.

To dynamically update the dynamic measurement value with movement of one or more objects (e.g., anatomical object 210) within scene 208, dynamic measurement system 202 may, at operation 412, determine whether movement of one or more vertices on the 3D contour of deformable 3D model 214 has occurred. For example, dynamic measurement system 202 may be configured to track movement of the plurality of nodes over time as one or more objects within scene 208 move and/or deform in the imagery captured by imaging device 204. Dynamic measurement system 202 may update the 3D locations of the vertices of deformable 3D model 214 with updated 3D locations of the corresponding nodes and determine whether the 3D locations of any of the identified vertices on the 3D contour of deformable 3D model 214 have moved.

If one or more of the identified vertices on the 3D contour have moved (yes, at operation 412), dynamic measurement system 202 may, at operation 414, update the dynamic measurement value. For example, dynamic measurement system 202 may recompute the sum of the distances between the updated 3D locations of the vertices on the 3D contour. If one or more vertices have not moved (no, at operation 412), dynamic measurement system 202, may continue to monitor for movement of the one or more vertices on the 3D contour. In some implementations, the operation 412 of determining whether movement of one or more vertices on the 3D contour of deformable 3D model 214 has occurred may be omitted. For example, the dynamic measurement value may be updated and/or recomputed at select intervals without determining whether movement of one or more vertices on the 3D contour of deformable 3D model 214 has occurred.

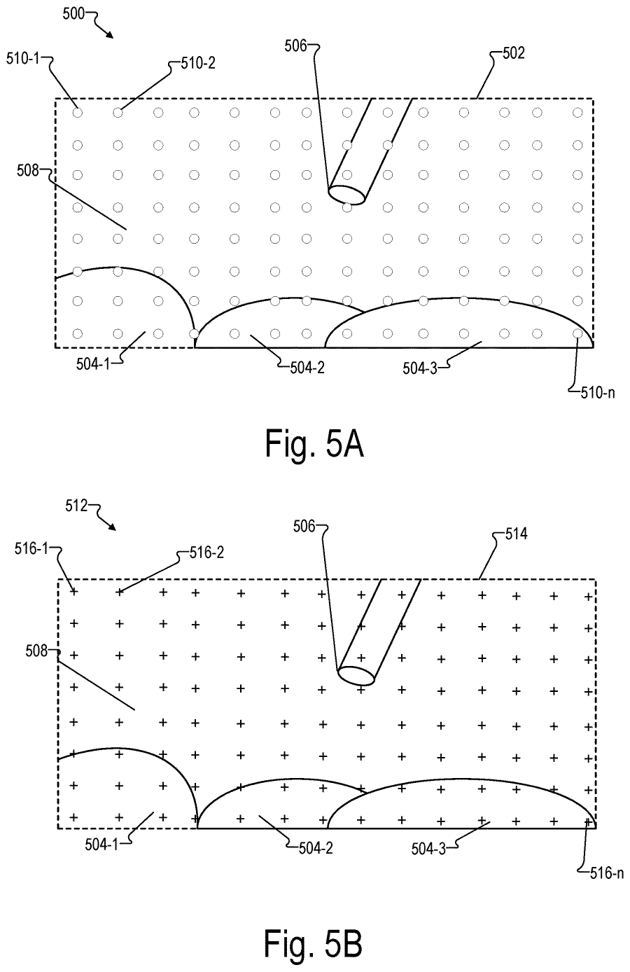

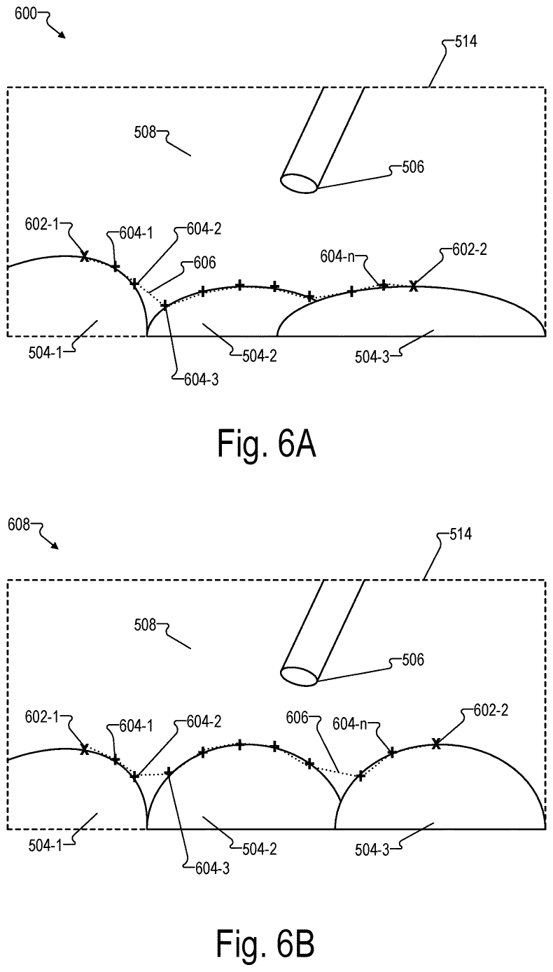

FIGS. 5A-6B show an illustrative example of determining a dynamic measurement value that may be performed by dynamic measurement system 202. For example, FIG. 5A shows an implementation 500 of imagery 502 of a scene (e.g., scene 208) that may be captured by imaging device 204. As shown, imagery 502 includes a plurality of anatomical objects 504 (e.g., anatomical objects 504-1 to 504-3) and a physical tool 506 spaced away from the plurality of anatomical objects 504 in an environment 508 (e.g., an area within a subject of a medical procedure). In the illustrated implementation 500, a point cloud has been generated by dynamic measurement system 202 that includes a plurality of nodes 510 (e.g., nodes 510-1 to 510-n). Nodes 510 may be representative of surface points on one or more objects (e.g., anatomical objects 504, physical tool 506, and/or environment 508) within the scene captured by imagery 502.

FIG. 5B shows an illustrative implementation 512 of a deformable 3D model 514 that may be generated by dynamic measurement system 202 based on imagery 502. Deformable 3D model 514 may implement or be similar to deformable 3D model 214. As shown, dynamic measurement system 202 may generate deformable 3D model 514 by deriving vertices 516 (e.g., vertices 516-1 to 516-n) with 3D locations associated with the 3D locations of the plurality of nodes 510. Accordingly, deformable 3D model 514 may depict one or more objects (e.g., anatomical objects 504, physical tool 506, and/or environment 508) within the scene captured by imagery 502. In some implementations, deformable 3D model 514 may be generated using a SLAM algorithm that may derive vertices 516 and track the location of vertices 516 as imaging device 204 captures imagery 502.

FIG. 6A shows an implementation 600 of two or more points 602 (e.g., points 602-1 to 602-2) identified on deformable 3D model 514. The two or more points 602 may be identified on imagery 502 and/or deformable 3D model 514, such as by receiving a user input (e.g., via user interface 206) designating the two or more points 602 on imagery 502 and/or deformable 3D model 514. As shown, a first point 602-1 has been designated on a first anatomical object 504-1 and a second point 602-2 has been designated on a third anatomical object 504-3 that is spaced away from first anatomical object 504-1 by a second anatomical object 504-2. The identified points 602 may be associated with vertices 516 of deformable 3D model 514 having 3D locations that correspond to the identified points 602.

Dynamic measurement system 202 may identify one or more intermediate vertices 604 (e.g., vertices 604-1 to 604-n) of deformable 3D model 514 between the identified points 602. For example, intermediate vertices 604 may include vertices 516 of deformable 3D model 514 having 3D locations positioned along a surface of deformable 3D model 514 between the identified points 602. In the illustrated implementation 600, intermediate vertices 604 extend along a surface of first anatomical object 504-1, second anatomical object 504-2, and third anatomical object 504-3 from first point 602-1 to second point 602-2. Dynamic measurement system 202 may further form a 3D contour 606 connecting the identified points 602 through intermediate vertices 604. For example, 3D contour 606 may be formed by connecting first point 602-1 and second point 602-2 through intermediate vertices 604 such that 3D contour 606 extends along the surfaces of first anatomical object 504-1, second anatomical object 504-2, and third anatomical object 504-3 from first point 602-1 to second point 602-2.

Dynamic measurement system 202 may determine a dynamic measurement value representative of a contour physical distance between the identified points 602 based on 3D contour 606. For example, dynamic measurement system 202 may sum the distances between the 3D locations of first point 602-1, intermediate vertices 604, and second point 602-2 to determine the dynamic measurement value.

In some implementations, movement of one or more objects within the scene depicted by imagery 502 may cause deformable 3D model 514 to deform. To illustrate, FIG. 6B shows another implementation 608 of deformable 3D model 514 in a deformed state. As shown, second anatomical object 504-2 and third anatomical object 504-3 have deformed such that the 3D locations of second point 602-2 and intermediate vertices 604 positioned on second anatomical object 504-2 and third anatomical object 504-3 have moved. Dynamic measurement system 202 may thereby update the dynamic measurement value, such as by recomputing the sum of the distances between the updated 3D locations of first point 602-1, intermediate vertices 604, and second point 602-2 on 3D contour 606. Dynamic measurement system 202 may use the same intermediate vertices 604 to recompute the sum of the distances between first and second points 602 and/or dynamic measurement system 202 may identify one or more different intermediate vertices 604 to recompute the sum of the distances between first and second points 602.

While FIGS. 6A and 6B show second point 602-2 located on a different anatomical object 504 than first point 602-1, second point 602-2 may be located on the same anatomical object 504 as first point 602-1. Additionally or alternatively, second point 602-2 may be located on physical tool 506 and/or any other area of environment 508. Accordingly, the dynamic measurement value may be updated with movement of one or more objects (e.g., anatomical objects 504 and/or physical tool 506) of deformable 3D model 514, which may cause the identified points 602 and/or intermediate vertices 604 located on the one or more objects to move and affect 3D contour 606.

Moreover, while FIGS. 6A and 6B show intermediate vertices 604 positioned along a surface of deformable 3D model 514 between first and second points 602 to form 3D contour 606, one or more of intermediate vertices 604 may be omitted such that 3D contour 606 may form a point-to-point distance between first and second points 602 and/or a combination of surface points and point-to-point distances between first and second points 602. Additionally or alternatively, dynamic measurement system 202 may receive user input to designate select intermediate vertices 604 such that a user may manipulate and/or adjust 3D contour 606 on deformable 3D model 514.

In some instances, deformable 3D model 514 may be incomplete (e.g., in areas not captured by imaging device 204) such that there may be holes or missing vertices in deformable 3D model 514. In these instances, dynamic measurement system 202 may be configured to perform a dynamic interpolation to estimate a 3D location for the missing vertices. For example, dynamic measurement system 202 may interpolate the 3D locations of the missing vertices based on the 3D locations of nearby known vertices. Moreover, dynamic measurement system 202 may update the 3D locations of the missing vertices based on the movement of the nearby known vertices with movement of one or more objects within the scene. In some implementations, dynamic measurement system 202 may be configured to perform the dynamic interpolation when 3D contour 606 crosses the incomplete area of deformable 3D model 514 (e.g., to reduce processing burden).

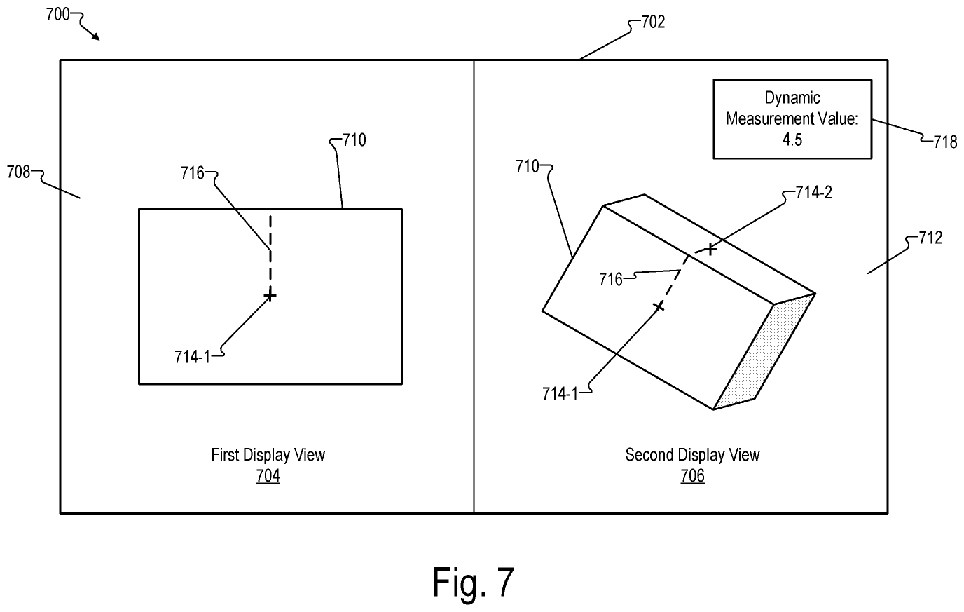

FIG. 7 shows an illustrative implementation 700 of a display 702 that may be displayed on display device 218. As shown, display 702 includes a first display view 704 and a second display view 706. First display view 704 may display imagery 708 of scene 208 as captured by imaging device 204. In the illustrated implementation 700, imagery 708 depicts an anatomical object 710. Second display view 706 may display a deformable 3D model 712 of anatomical object 710 that may be generated by dynamic measurement system 202 based on imagery 708. Deformable 3D model 712 may implement or be similar to deformable 3D model 214 and/or deformable 3D model 514.

Display 702 may further depict a first point 714-1 on anatomical object 710 (e.g., an outer surface of anatomical object 710) in imagery 708 and/or deformable 3D model 712. For example, dynamic measurement system 202 may receive a user input (e.g., a touch gesture, a button press, a mouse click, a button release, etc.) on any point of imagery 708 and/or deformable 3D model 712 of display 702 to designate first point 714-1. Display 702 may further depict a second point 714-2 in imagery 708 and/or deformable 3D model 712. In the illustrated implementation 700, second point 714-2 is positioned on anatomical object 710 (e.g., an outer surface of anatomical object 710). Dynamic measurement system 202 may also receive a user input (e.g., a touch gesture, a button press, a mouse click, a button release, etc.) on any point of imagery 708 and/or deformable 3D model 712 of display 702 to designate second point 714-2.

In some implementations, first display view 704 and second display view 706 may be coupled such that imagery 708 in first display view 704 moves simultaneously with deformable 3D model 712 in second display view 706. For example, imaging device 204 may be moved (e.g., panned, rotated, zoomed, etc.) such that imagery 708 may depict anatomical object 710 at different viewpoints in first display view 704. As imagery 708 of anatomical object 710 moves, deformable 3D model 712 may simultaneously move with imagery 708 such that the viewpoint of anatomical object 710 in second display view 706 corresponds to the viewpoint of anatomical object 710 in first display view 704.

Additionally or alternatively, first display view 704 and second display view 706 may be uncoupled such that deformable 3D model 712 in second display view 706 may move (e.g., pan, rotate, zoom, etc.) independently from imagery 708 in first display view 704. For example, a user may provide a user input to move deformable 3D model 712 within second display view 706 without moving imaging device 204 and/or changing imagery 708 displayed in first display view 704. This may allow the user to view a larger area and/or a different viewpoint of anatomical object 710 in deformable 3D model 712 without moving imaging device 204 and/or changing imagery 708 displayed in first display view 704.

In some implementations, the user may designate first point 714-1, move deformable 3D model 712 in second display view 706 without moving imaging device 204 and/or changing imagery 708 displayed in first display view 704, and designate second point 714-2 on deformable 3D model 712 in second display view 706. This may allow second point 714-2 to be designated on an area of anatomical object 710 that may be occluded in imagery 708 and/or may be outside of the field of view of imaging device 204 capturing imagery 708. For example, first point 714-1 may be positioned in a first field of view of imaging device 204 that captures imagery 708 and second point 714-2 may positioned in a second field of view of imaging device 204 that is different than the first field of view.

Once first point 714-1 and second point 714-2 have been identified, dynamic measurement system 202 may determine the dynamic measurement value representative of a contour physical distance between first point 714-1 and second point 714-2. For example, dynamic measurement system 202 may identify a 3D contour 716 extending between first point 714-1 and second point 714-2 along a surface of anatomical object 710 and determine a distance of 3D contour 716. In some implementations, a display of 3D contour 716 and/or dynamic measurement value 718 may be displayed on display device 218, such as on imagery 708 in first display view 704 and/or deformable 3D model 712 in second display view 706.

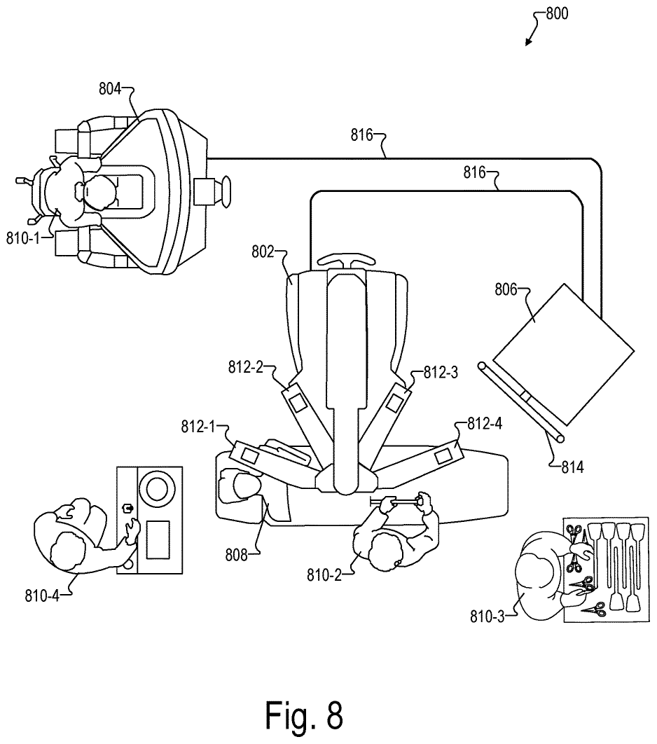

As has been described, dynamic measurement system 202, imaging device 204, user interface 206, and/or physical tool 506 may be associated in certain examples with a computer-assisted medical system used to perform a medical procedure on a body. To illustrate, FIG. 8 shows an illustrative computer-assisted medical system 800 that may be used to perform various types of medical procedures including surgical and/or non-surgical procedures.

As shown, computer-assisted medical system 800 may include a manipulator assembly 802 (a manipulator cart is shown in FIG. 8), a user control apparatus 804, and an auxiliary apparatus 806, all of which are communicatively coupled to each other. Computer-assisted medical system 800 may be utilized by a medical team to perform a computer-assisted medical procedure or other similar operation on a body of a patient 808 or on any other body as may serve a particular implementation. As shown, the medical team may include a first user 810-1 (such as a surgeon for a surgical procedure), a second user 810-2 (such as a patient-side assistant), a third user 810-3 (such as another assistant, a nurse, a trainee, etc.), and a fourth user 810-4 (such as an anesthesiologist for a surgical procedure), all of whom may be collectively referred to as users 810, and each of whom may control, interact with, or otherwise be a user of computer-assisted medical system 800. More, fewer, or alternative users may be present during a medical procedure as may serve a particular implementation. For example, team composition for different medical procedures, or for non-medical procedures, may differ and include users with different roles.

While FIG. 8 illustrates an ongoing minimally invasive medical procedure such as a minimally invasive surgical procedure, it will be understood that computer-assisted medical system 800 may similarly be used to perform open medical procedures or other types of operations. For example, operations such as exploratory imaging operations, mock medical procedures used for training purposes, and/or other operations may also be performed.

As shown in FIG. 8, manipulator assembly 802 may include one or more manipulator arms 812 (e.g., manipulator arms 812-1 through 812-4) to which one or more instruments may be coupled. The instruments may be used for a computer-assisted medical procedure on patient 808 (e.g., in a surgical example, by being at least partially inserted into patient 808 and manipulated within patient 808). While manipulator assembly 802 is depicted and described herein as including four manipulator arms 812, it will be recognized that manipulator assembly 802 may include a single manipulator arm 812 or any other number of manipulator arms as may serve a particular implementation. While the example of FIG. 8 illustrates manipulator arms 812 as being robotic manipulator arms, it will be understood that, in some examples, one or more instruments may be partially or entirely manually controlled, such as by being handheld and controlled manually by a person. For instance, these partially or entirely manually controlled instruments may be used in conjunction with, or as an alternative to, computer-assisted instrumentation that is coupled to manipulator arms 812 shown in FIG. 8.

During the medical operation, user control apparatus 804 may be configured to facilitate teleoperational control by user 810-1 of manipulator arms 812 and instruments attached to manipulator arms 812. To this end, user control apparatus 804 may provide user 810-1 with imagery of an operational area associated with patient 808 as captured by an imaging device. To facilitate control of instruments, user control apparatus 804 may include a set of master controls. These master controls may be manipulated by user 810-1 to control movement of the manipulator arms 812 or any instruments coupled to manipulator arms 812.

Auxiliary apparatus 806 may include one or more computing devices configured to perform auxiliary functions in support of the medical procedure, such as providing insufflation, electrocautery energy, illumination or other energy for imaging devices, image processing, or coordinating components of computer-assisted medical system 800. In some examples, auxiliary apparatus 806 may be configured with a display monitor 814 configured to display one or more user interfaces, or graphical or textual information in support of the medical procedure. In some instances, display monitor 814 may be implemented by a touchscreen display and provide user input functionality. Augmented content provided by a region-based augmentation system may be similar, or differ from, content associated with display monitor 814 or one or more display devices in the operation area (not shown).

Manipulator assembly 802, user control apparatus 804, and auxiliary apparatus 806 may be communicatively coupled to another in any suitable manner. For example, as shown in FIG. 8, manipulator assembly 802, user control apparatus 804, and auxiliary apparatus 806 may be communicatively coupled by way of control lines 816, which may represent any wired or wireless communication link as may serve a particular implementation. To this end, manipulator assembly 802, user control apparatus 804, and auxiliary apparatus 806 may each include one or more wired or wireless communication interfaces, such as one or more local area network interfaces, Wi-Fi network interfaces, cellular interfaces, and so forth.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a compact disc read-only memory (“CD-ROM”), a digital video disc (“DVD”), any other optical medium, random access memory (“RAM”), programmable read-only memory (“PROM”), electrically erasable programmable read-only memory (“EPROM”), FLASH-EEPROM, any other memory chip or cartridge, or any other tangible medium from which a computer can read.

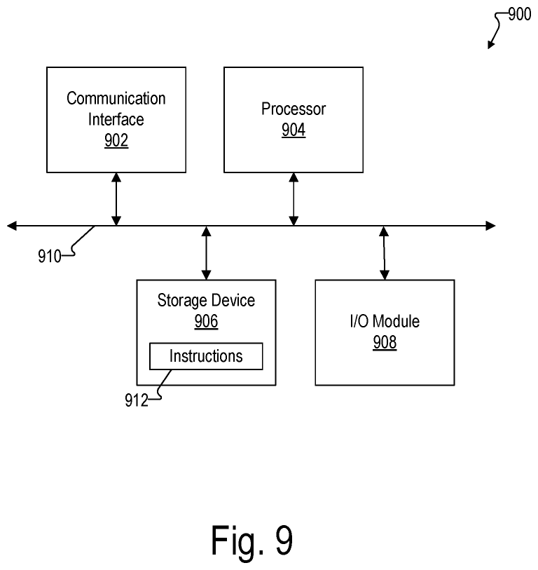

FIG. 9 shows an illustrative computing device 900 that may be specifically configured to perform one or more of the processes described herein. Any of the systems, computing devices, and/or other components described herein may be implemented by computing device 900.

As shown in FIG. 9, computing device 900 may include a communication interface 902, a processor 904, a storage device 906, and an input/output (“I/O”) module 908 communicatively connected one to another via a communication infrastructure 910. While an illustrative computing device 900 is shown in FIG. 9, the components illustrated in FIG. 9 are not intended to be limiting. Additional or alternative components may be used in other embodiments. Components of computing device 900 shown in FIG. 9 will now be described in additional detail.

Communication interface 902 may be configured to communicate with one or more computing devices. Examples of communication interface 902 include, without limitation, a wired network interface (such as a network interface card), a wireless network interface (such as a wireless network interface card), a modem, an audio/video connection, and any other suitable interface.

Processor 904 generally represents any type or form of processing unit capable of processing data and/or interpreting, executing, and/or directing execution of one or more of the instructions, processes, and/or operations described herein. Processor 904 may perform operations by executing computer-executable instructions 912 (e.g., an application, software, code, and/or other executable data instance) stored in storage device 906.

Storage device 906 may include one or more data storage media, devices, or configurations and may employ any type, form, and combination of data storage media and/or device. For example, storage device 906 may include, but is not limited to, any combination of the non-volatile media and/or volatile media described herein. Electronic data, including data described herein, may be temporarily and/or permanently stored in storage device 906. For example, data representative of computer-executable instructions 912 configured to direct processor 904 to perform any of the operations described herein may be stored within storage device 906. In some examples, data may be arranged in one or more databases residing within storage device 906.

I/O module 908 may include one or more I/O modules configured to receive user input and provide user output. I/O module 908 may include any hardware, firmware, software, or combination thereof supportive of input and output capabilities. For example, I/O module 908 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 908 is configured to provide graphical data to a display for presentation to a user. The graphical data may be representative of one or more graphical user interfaces and/or any other graphical content as may serve a particular implementation.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

1. A system comprising:
a memory storing instructions; and
one or more processors communicatively coupled to the memory and configured to execute the instructions to perform a process comprising:
generating, based on imagery of a scene, a deformable three-dimensional (3D) model of the scene;
identifying a first point on an anatomical object located in the scene; and
determining, based on the deformable 3D model, a dynamic measurement value representative of a contour physical distance between the first point and a second point in the scene, wherein the dynamic measurement value dynamically updates with movement of one or more objects within the scene.

2. The system of claim 1, wherein at least one of the first point or the second point is on an outer surface of the anatomical object.

3. The system of claim 1, wherein at least one of the first point or the second point moves as the anatomical object is deformed.

4. The system of claim 1, wherein the generating the deformable 3D model includes using a simultaneous localization and mapping heuristic.

5. The system of claim 1, wherein the identifying the first point includes detecting a user input designating the first point within a select one or both of the imagery of the scene or the deformable 3D model.

6. The system of claim 1, wherein the identifying the first point includes using a machine learning algorithm to designate the first point on the anatomical object located in the scene.

7. The system of claim 1, further comprising identifying the second point in the scene, the identifying the second point comprising detecting a user input designating the second point within a select one or both of the imagery of the scene or the deformable 3D model.

8. The system of claim 1, further comprising identifying the second point in the scene by using a machine learning algorithm to designate the second point in the scene.

9. The system of claim 1, wherein the imagery of the scene comprises stereoscopic images captured by an imaging device.

10. The system of claim 1, wherein the first point is positioned in a first field of view of an imaging device that captures the imagery and the second point is positioned in a second field of view of the imaging device that is different than the first field of view.

11. The system of claim 1, wherein the process further comprises instructing one or more display devices to display the imagery depicting the scene in a first display view and the deformable 3D model in a second display view.

12. The system of claim 11, wherein the first display view is coupled with the second display view such that the imagery depicting the scene in the first display view moves simultaneously with the deformable 3D model in the second display view.

13. The system of claim 11, wherein the first display view is uncoupled from the second display view such that the deformable 3D model in the second display view moves independently from the imagery depicting the scene in the first display view.

14. The system of claim 11, wherein the process further comprises instructing the display device to display a 3D contour extending between the first point and the second point along a surface of the one or more objects within the scene, wherein the 3D contour is representative of the contour physical distance.

15. The system of claim 1, wherein the process further comprises performing an operation based on the dynamic measurement value.

16. A method comprising:
generating, by at least one computing device and based on imagery of a scene, a deformable three-dimensional (3D) model of the scene;
identifying, by the at least one computing device, a first point on an anatomical object located in the scene; and
determining, by the at least one computing device and based on the deformable 3D model, a dynamic measurement value representative of a contour physical distance between the first point and a second point in the scene, wherein the dynamic measurement value dynamically updates with movement of one or more objects within the scene.

17. The method of claim 16, wherein at least one of the first point or the second point is on an outer surface of the anatomical object.

18. The method of claim 16, wherein at least one of the first point or the second point moves as the anatomical object is deformed.

19. The method of claim 16, wherein the generating the deformable 3D model includes using a simultaneous localization and mapping heuristic.

20.-29. (canceled)

30. A non-transitory computer-readable medium storing instructions that, when executed, direct a processor of a computing device to perform a process comprising:
generating, based on imagery of a scene, a deformable three-dimensional (3D) model of the scene;
identifying a first point on an anatomical object located in the scene; and
determining, based on the deformable 3D model, a dynamic measurement value representative of a contour physical distance between the first point and a second point in the scene, wherein the dynamic measurement value dynamically updates with movement of one or more objects within the scene.
